(19) United States
(12) Patent Application Publication
(10) Pub. No.: US 2008/0184694 A1
(43) Pub. Date: Aug. 7, 2008

(54) GAS TURBINE WITH CONTRAROTATING HP AND LP TURBINES

(75) Inventors: Jean-Michel Bernard Guimbard, Cely en Biere (FR); Renaud Martet, Palaiseau (FR); Eric Schwartz, Seine Port (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/026,033

(22) Filed: Feb. 5, 2008

(30) Foreign Application Priority Data
Feb. 7, 2007 (FR) 07 53105

(51) Int. Cl. F02K 3/02

(52) U.S. Cl. 60/224; 415/62

(57) ABSTRACT

A gas turbine with contrarotating HP and LP turbines comprises an LP turbine having a plurality of moving wheels alternating with nozzles, the moving wheels of the LP turbine rotating in a direction opposite to the direction of rotation of the moving wheel of the HP turbine, and an inter-turbine casing having inner and outer casing walls defining a stream passage between the HP and LP turbines together with arms extending across the passage between the inner and outer casing walls. The gas turbine does not have a nozzle or device for forming the function of deflecting the stream between the outlet from the HP turbine and the first moving wheel of the LP turbine. The HP turbine is advantageously designed to deliver a stream that gyrates in the inter-turbine casing.

### BACKGROUND OF THE INVENTION

The invention relates to a gas turbine having contrarotating high pressure (HP) and low pressure (LP) turbines, i.e. turbines in which the or each HP turbine wheel rotates in a direction opposite to the direction of rotation of the moving wheels of the LP turbine. The field of application of the invention is more particularly that of aeroengines.

The invention is not limited to turbines having two spools, one HP and the other LP. It may also be applied to turbines having more than two spools, where the terms high pressure (HP) turbine and low pressure (LP) turbine then apply to two turbines of two consecutive spools in the flow direction of the stream through the gas turbine.

The use of contrarotating HP and LP turbines is advantageous in that the need for deflecting the outlet stream from the HP turbine is smaller, so aerodynamic losses due to the inlet nozzle of the LP turbine are reduced. The performance of the turbine function is thus improved.

For reasons of structural strength, an intermediate casing or “inter-turbine” casing can be interposed between the HP and LP turbines that are themselves housed in their respective casings. The intermediate casing has inner and outer walls defining the flow section for the stream between the HP and LP turbines, together with arms extending between the inner and outer walls.

One such configuration is shown very diagrammatically in FIG. 1. The HP turbine 10 comprises a nozzle 12 receiving the primary stream coming from the combustion chamber and deflecting it to apply it to a moving wheel 16 turning in one direction (arrow F1). The LP turbine 20 comprises a plurality of stages each having a nozzle 22₁, 22₂, . . . , 22ₙ and a moving wheel 26₁, 26₂, . . . , 26ₙ, these moving wheels turning in a direction (arrow F2) that is opposite to the direction of the wheel 16. An inter-turbine casing 30 is interposed between the turbines 10 and 20 with arms 22 extending across the passage for the stream, the arms 32 being faired in order to minimize aerodynamic losses. Nevertheless, the presence of the inter-turbine casing leads to losses of pressure, thereby causing a drop in the overall performance of the turbine.

As shown very diagrammatically in FIG. 2, proposals have been made to eliminate the nozzle at the inlet stage of the LP turbine and to give a deflecting function to the inter-turbine casing 36 (the other elements being similar to those of FIG. 1 and being given the same references). The arms 38 of the inter-turbine casing are then given a shape that is appropriate for a deflecting vane. Nevertheless, a loss of performance is still observed compared with a configuration that does not have an inter-turbine casing. Each arm is subjected to higher levels of geometrical stress (in terms of cord length and maximum cross-section) and therefore generates pressure losses that are greater than would be generated by a conventional nozzle for the first stage of an LP turbine.

### OBJECT AND SUMMARY OF THE INVENTION

The invention proposes providing a configuration for contrarotating HP and LP turbines together with an inter-turbine casing that enables aerodynamic performance to be optimized, and that also enables weight and cost to be optimized.

This object is achieved by a gas turbine comprising:

a high pressure (HP) turbine; a low pressure (LP) turbine with a plurality of moving wheels alternating with nozzles, the moving wheels of the LP turbine rotating in a direction opposite to the direction of rotation of the moving wheel of the HP turbine; and an inter-turbine casing having inner and outer casing walls defining a stream passage between the HP and LP turbines with arms extending across the passage between the inner and outer casing walls,

the turbine not having a nozzle or a device with the function of deflecting the stream between the outlet from the HP turbine and the first moving wheel of the LP turbine.

Thus, while omitting the nozzle for the first stage of the LP turbine, the inter-turbine casing is given a role that is structural only, to the exclusion of any stream-deflecting role. The absence of stream-deflecting at the first stage of the LP turbine does indeed lead to a certain amount of deterioration in load distribution over the LP turbine compared with prior art configurations, however this degradation is compensated by the savings associated with reducing the number of blades. In the inter-turbine casing, the arms do not perform any stream-deflecting function, so they can be present in limited number, merely being sufficient to perform the structural function of the casing. Furthermore, non-deflecting arms of this type generate smaller pressure losses than do arms having a deflecting shape, so secondary losses are greatly reduced as are losses due to the shape of the profile. In addition, the moving wheel of the first stage of the LP turbine that receives a non-deflected stream has a smaller amount of deflection to impart to the stream and can therefore have a smaller number of blades. This is in addition to completely omitting the inlet nozzle for the LP turbine.

Reducing the number of blades also gives rise to significant reductions in terms of weight and cost.

Preferably, in order to have a good performance budget, the HP turbine is designed to deliver a gyrating stream to the inter-turbine casing, with the general direction of the stream exiting the HP turbine forming an angle of not less than 20° relative to the axial direction of the turbine, for example, and at least for those operating points where best performance is looked for.

The invention also provides a gas turbine engine fitted with a turbine as defined above.

### BRIEF DESCRIPTION OF THE DRAWINGS

The invention can be better understood on reading the following description given by way of non-limiting indication and with reference to the accompanying drawings, in which:

FIGS. 1 and 2, described above, show very diagrammatically prior art configurations for contrarotating HP and LP turbines;

FIG. 3 shows very diagrammatically a gas turbine engine in which the invention can be implemented;

FIG. 4 shows very diagrammatically a configuration of the invention for contrarotating HP and LP turbines; and

FIG. 5 is a simplified fragmentary view in axial half-section of an assembly comprising an HP turbine, an inter-turbine casing, and an LP turbine in an embodiment of the invention.

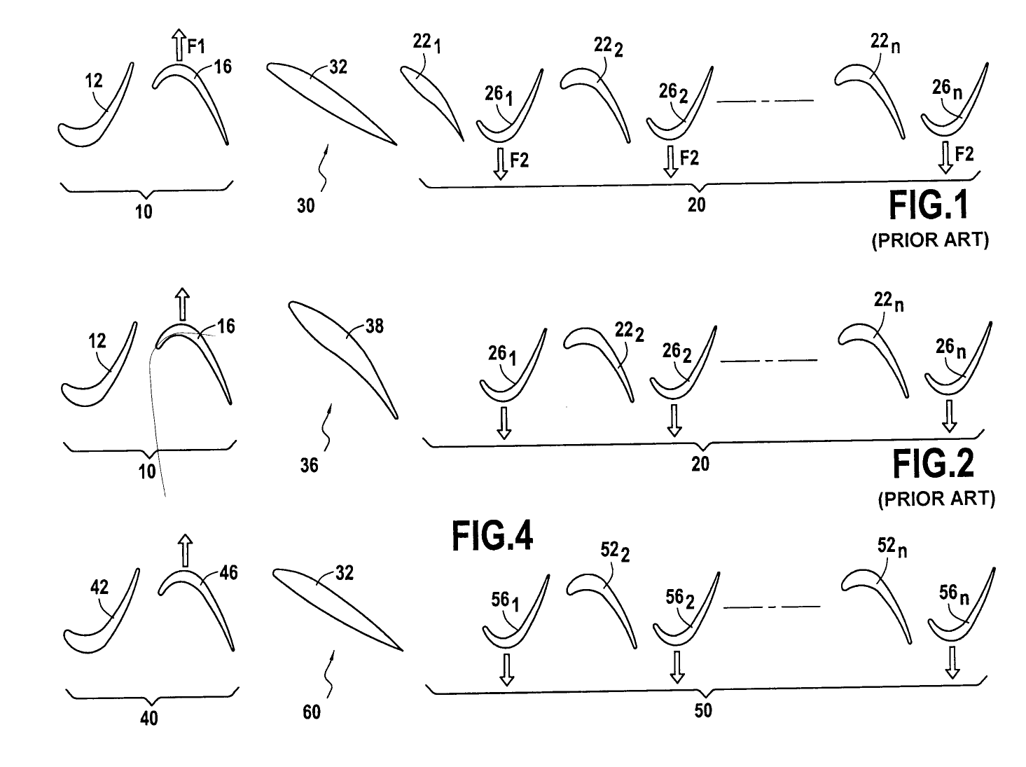

### DETAILED DESCRIPTION OF EMBODIMENTS

The invention is particularly applicable to gas turbine aeroengines. Such an engine, as shown very diagrammatically in FIG. 3, comprises from upstream to downstream in the gas flow direction: a fan 1 disposed at the inlet of the engine; a compressor 2; a combustion chamber 3; a high pressure (HP) turbine 4; and a low pressure (LP) turbine 5. The HP and LP turbines are coupled to the compressors and to the fan respectively by coaxial shafts.

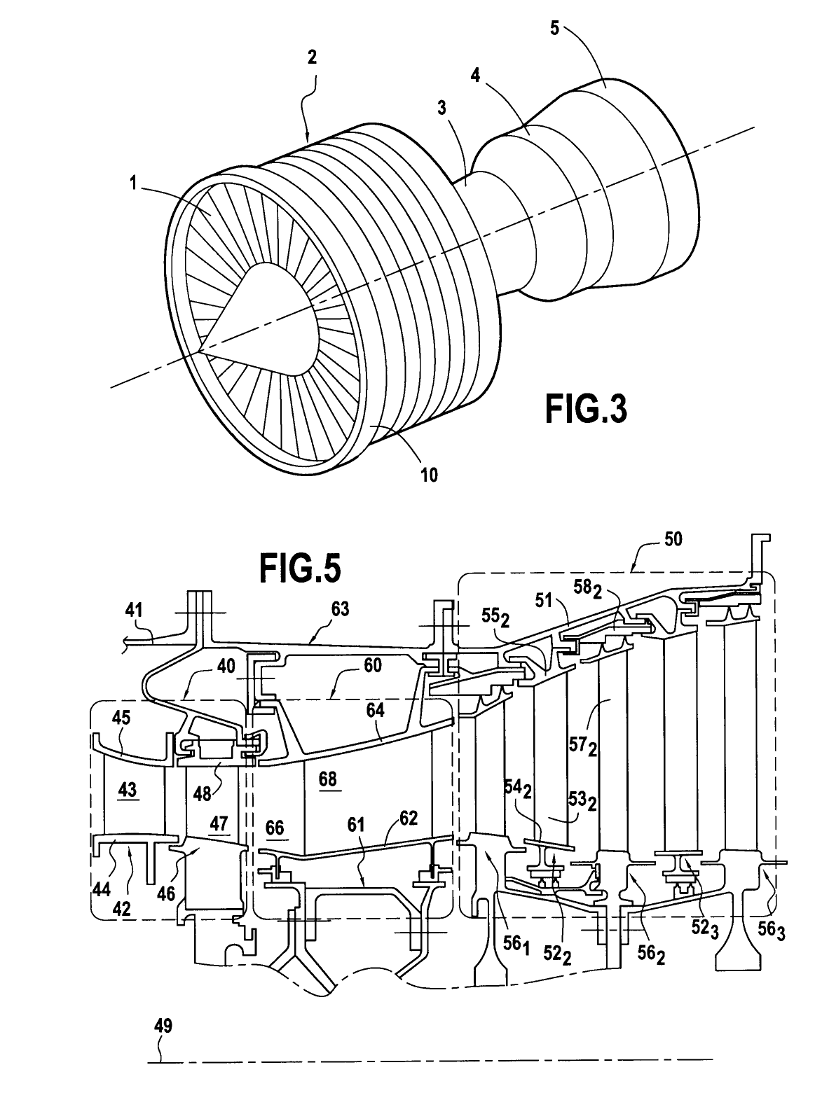

Configurations in accordance with the invention of an assembly comprising an HP turbine, an inter-turbine casing, and an LP turbine are shown in highly diagrammatic manner in FIG. 4 and in fragmentary axial half-section in FIG. 5.

In these examples, the HP turbine 40 comprises a single turbine stage with a turbine inlet nozzle 42 receiving a primary gas stream coming from the combustion chamber (not shown) and a moving wheel 46 with the gas stream delivered by the HP turbine exiting immediately downstream therefrom. The nozzle 42 comprises stationary vanes 43 that extend across the space defined by the inner and outer platforms 44 and 45, which space forms the inlet flow section for the gas stream into the turbine. The moving wheel 46 comprises blades 47 that move in rotation in a space that is surrounded by an outer turbine ring 48. The moving wheel 46 is movable in rotation about the axis 49 of the turbine and it is coupled to a turbine shaft (not shown).

The LP turbine comprises a plurality of turbine stages. The first stage, or the furthest-upstream stage, comprises a moving wheel 56₁ that is not preceded by an inlet nozzle for the LP turbine, whereas each following stage comprises a nozzle 52₂, . . . , 52ₙ together with a moving wheel 56₂, . . . , 56ₙ, where n is an integer greater than two, and is preferably not less than three. In the example of FIG. 5, the number of LP turbine stages is equal to three, with moving wheels 56₁, 56₂, 56₃ and nozzles 52₂, 52₃. The moving wheels of the LP turbine are movable in rotation about the axis 49 in a direction that is opposite to the direction of rotation of the moving wheel 46, and they are connected to a turbine shaft (not shown). Each LP turbine nozzle, e.g. 52₂, comprises vanes 53₂ that extend across the space defined by the inner and outer nozzle rings 54₂, 55₂. Each moving wheel of the LP turbine, e.g. 56₂, has blades 57₂ that are movable in rotation in a space surrounded by an outer turbine ring 58₂.

The inter-turbine casing 60 that performs a structural function only is inserted between the HP and LP turbines. The casing 60 comprises inner and outer casing structures 61 and 63 that support inner and outer walls 62 and 64 defining between them the passage 66 for the gas stream between the HP and LP turbines. Structural arms 68 extend across the stream throughout the width of the passage 66 between the walls 62 and 64 and are connected thereto. The arms 68 are faired to minimize aerodynamic losses in the passage 66, but they are not shaped to perform a stream deflecting function as in the example of FIG. 2. The number of arms can therefore be limited to a number that is sufficient for performing the expected structural function. It should be observed that the structure of the outer casing 63 is connected to outer casing structures 41 and 51 of the HP and LP turbines.

With a configuration in accordance with the invention, the upstream moving wheel 56₁ of the LP turbine is lightly loaded. It can therefore be made with a limited number of blades. To compensate the light loading on the wheel 56₁, it is possible to provide greater loading on the wheels 56₂ and 56₃ in comparison with a conventional configuration in which there is a nozzle upstream from the first moving wheel of the LP turbine.

Advantageously, in order to have a good performance budget from the wheel 56₁, it is desirable to impose a relatively large amount of gyration about the axis 49 on the gas stream coming from the HP turbine. Preferably, the angle between the general direction of the gas stream coming from the HP turbine and the axis 49, as imparted by the moving wheel 46, should not be less than 30°, e.g. lying in the range 20° to 45°.

In spite of the absence of an inlet nozzle for the LP turbine, and thus while in the presence of loading unbalance between the moving wheels of the LP turbine, the saving in terms of weight and cost for the number of blades makes it possible to obtain a performance budget that is positive overall in comparison with the prior art.

What is claimed is:

1. A gas turbine comprising: a high pressure turbine; a low pressure turbine with a plurality of moving wheels alternating with nozzles, the moving wheels of the LP turbine rotating in a direction opposite to the direction of rotation of the moving wheel of the HP turbine; and an inter-turbine casing having inner and outer casing walls defining a stream passage between the HP and LP turbines with arms extending across the passage between the inner and outer casing walls;
the gas turbine not having a nozzle or device for having the function of deflecting the stream between the outlet from the HP turbine and the first moving wheel of the LP turbine.

2. A gas turbine according to claim 1, wherein the HP turbine is designed to deliver a stream that gyrates in the inter-turbine casing.

3. A gas turbine according to claim 2, wherein the general direction of the stream exiting the HP turbine forms an angle of not less than 20° relative to the axial direction of the turbine.

4. A gas turbine engine fitted with a turbine according to claim 1.
